(19) United States
(12) Patent Application Publication
(10) Pub. No.: US 2025/0354767 A1
(43) Pub. Date: Nov. 20, 2025

(54) METHOD FOR MANUFACTURING A HEAT EXCHANGE GRAPHITE ASSEMBLY, CORRESPONDING ASSEMBLY AND TUBE BUNDLE HEAT EXCHANGER COMPRISING THE SAME

(71) Applicant: MERSEN FRANCE PY SAS, PAGNY-SUR-MOSELLE (FR)

(72) Inventors: Frédéric THUMMEN, PAGNY SUR MOSELLE (FR); Jérémie BENOIT, PONT A MOUSSON (FR); Jérôme DORNIER, MALZEVILLE (FR)

(73) Assignee: MERSEN FRANCE PY SAS, PAGNY-SUR-MOSELLE (FR)

(21) Appl. No.: 18/866,130

(22) PCT Filed: May 10, 2023
(86) PCT No.: PCT/IB2023/054819

§ 371 Date: Nov. 15, 2024

(30) Foreign Application Priority Data
May 18, 2022 (EP) 22174014.5

(51) Int. Cl. F28F 9/16; F28D 1/053; F28F 9/22; F28F 21/02

(52) U.S. Cl. CPC F28F 9/162; F28D 1/05316; F28F 21/02; F28F 2009/226; F28F 2255/00

(57) ABSTRACT

This method comprises the following steps: —providing tubes (2), tube sheets (4) and baffle(s) in a graphite material in a non-impregnated state, positioning tubes, tube sheets and baffle (s) in their non-impregnated state, substantially in the precise position they are intended to occupy, so as to create a functional clearance between tubes and tube sheets impregnating graphite with an impregnation product different from a cement, so as to fill in the pores and so as to form, in said clearance, a bonding film (30) made of said impregnating product, in order to firmly attach the tubes with respect to the tube sheets. Among others, this method makes it possible to avoid any problem due to potential corrosion and leak, has a significantly reduced duration, is improved for what concerns environmental issues and makes it possible to increase both heat transfer area and thermal conductivity of the final exchanger.

### TECHNICAL FIELD OF THE INVENTION

The invention relates to the technical field of tube bundle heat exchangers. It deals more particularly with an improved manufacturing method of a heat exchange graphite assembly, which is part of such a tube bundle exchanger. The invention also relates to a heat exchange graphite assembly, in particular obtained according this method, as well as to an exchanger which is equipped with such a graphite assembly.

### PRIOR ART

Numerous types of heat exchangers are known, of which mention shall be made inter alia of plate, block or fin exchangers. The invention relates more particularly to a tube bundle-type heat exchanger, which typically comprises an external shell accommodating a so-called heat exchange assembly. According to the present invention, the latter is advantageously made of graphite, since this material makes it possible to resist to highly corrosive fluids and high temperatures.

Said graphite assembly first comprises a plurality of tubes forming a bundle, as well as two so-called tube sheets or tube plates provided at the opposite ends of said tubes. Moreover one or several baffles are provided in one or several intermediate locations, with reference to the longitudinal direction of the tubes. The shell of the exchanger defines an inlet chamber and an outlet chamber for a first fluid, also called process fluid, which generally extend both along main axis of the exchanger. Moreover this shell is also equipped with inlet pipe and outlet pipe for a second fluid, also called service fluid, which generally extend both in a transverse manner.

In use first fluid, which is typically a liquid or a gas, flows from inlet chamber through the inner volume of the tubes and thereafter in the outlet chamber. In parallel second fluid, which is typically water or steam water, flows from inlet pipe in the volume delimited between the inner surface of the shell and the outer surfaces of the pipes. Under these conditions, a heat exchange between said fluids take place through the tube walls. So as to ensure an appropriate implementation, the tube sheets need to be perfectly sealed with respect to the inner wall of the shell.

An example of a tube bundle heat exchanger of the above type is the exchanger marketed by the applicant under reference POLYTUBE®. The manufacturing method of the heat exchange graphite assembly, part of this exchanger, is the following.

First the tubes, the tube sheets and the baffles are submitted to an impregnation step, typically in a vessel containing an appropriate resin. Then these impregnated parts undergo further machining steps. In particular, the opposite ends of the tubes are tapered so as to be fixed in holes provided in each tube sheet.

This tapered shape makes it possible to create a free space, between the wall of each hole and the facing external wall of the tube. This space is then filled with a cement, which leads to the mutual attachment between the tube and the tube sheet. In a typical way, this cement is a mixture of phenolic resin and graphite powder.

The POLYTUBE® exchanger has exhibited very satisfactory performances, over decades. Indeed it defines a large heat transfer area and it shows a superior thermal conductivity, as well as a high mechanical strength.

Other solutions have been proposed, as variants of this graphite assembly.

First U.S. Pat. No. 4,474,233 discloses a tube bundle, wherein each tube is surrounded by graphite fibers. This makes it possible to improve the dynamics strength of these graphite tubes.

Moreover CN 101539379 describes an exchanger, wherein each tube is a modified phenolic resin graphite extruded tube that has been treated at a medium temperature of 300° C. Due to this treatment, its thermal stability and chemical stability are improved, and its linear expansion coefficient is greatly reduced.

Finally CN 211120768 proposes a heat exchanger, wherein the tube plates define a row of chambers, arranged side-by-side. The fluid thus circulates along a back and forth motion, between these tube plates.

On the other hand CN 107560463, CN 202648479 and CN113028864 disclose several methods for impregnation of the graphite being part of the exchanger. In particular CN 107560463 proposes to place the graphite elements in a solution made of PTFE prepolymer.

EP 0 744 587 describes a graphite heat exchange assembly, comprising silicon carbide tube inserts. Silicon carbide is a specific material, the requirements of which are different from those of graphite.

In view of the above there is a need to improve the manufacturing process of the heat exchange graphite assembly, which has been above described, as well as to improve the tube bundle exchanger equipped with this assembly.

That being said, one aim of the present invention is providing a manufacturing method which makes it possible to substantially avoid any problem, due to potential corrosion and leak of said assembly.

A further aim of the present invention is providing such a manufacturing method, the global duration of which and the labor time of which are significantly reduced.

A further aim of the present invention is providing such a manufacturing method, which is improved for what concerns environmental issues.

A further aim of the present invention is providing such a manufacturing method, which makes it possible to still increase both heat transfer area and thermal conductivity of the final exchanger.

A further aim of the present invention is providing such a manufacturing method, which improves the transportation of spare parts, not only in terms of costs but also in terms of mechanical damage risks.

A further aim of the invention is providing such a method, which makes it possible to manufacture a heat exchange graphite assembly that can be easily integrated in a shell of prior art exchangers.

Still a further aim of the invention is providing such a method, which leads to the manufacturing of an exchanger having substantially the same mechanical strength and pressure design with respect to prior art.

### OBJECTS OF THE INVENTION

At least one of the above aims is achieved by a first object of invention, which is a manufacturing method of a heat exchange graphite assembly (1), said assembly being intended to be part of a tube bundle heat exchanger (I), said assembly comprising
a plurality of tubes (2) forming a bundle (20)
two tube sheets (4, 5) provided at opposite ends of said tubes, each tube sheet comprising through holes (20) for the reception of said tubes
at least one baffle (6, 7) provided at intermediate location of said tubes, each baffle comprising openings (60) for the passage of said tubes
   said manufacturing method comprising
providing said tubes, said tube sheets as well as said baffle(s) in a graphite material being in a so-called non-impregnated or porous state, namely with a first value of porosity
positioning said tubes, said tube sheets as well as said baffle(s) in their porous state, substantially in the precise position they are intended to occupy, so as to create a functional clearance (230) between the facing walls of said tubes and said holes
impregnating said tubes, said tube sheets as well as said baffle(s) with an impregnation product different from a cement,
   so as to fill in the pores of said tubes, said tube sheets as well as said baffle(s), in order to confer to graphite material a second value of porosity, well inferior to said first value of porosity; and
   so as to form, in said clearance, a bonding film (30) made of said impregnating product, in order to firmly attach the tubes with respect to the tube sheets.

According to advantageous features of this manufacturing method:
transverse dimension or thickness (t230) of said clearance (230) is between 0.005 mm and 0.5 mm, in particular between 0.01 mm and 0.1 mm.
no cement is inserted in said clearance.
impregnating said tubes, said tube sheets as well as said baffle(s) comprises
   placing in a vessel said tubes, said tube sheets as well as said baffle(s),
   filling said vessel with said impregnation product, in particular from the bottom of said vessel,
   contacting said tubes, said tube sheets as well as said baffle(s) with said impregnation product and emptying said impregnation product.
contacting duration, between said tubes, said tube sheets as well as said baffle(s) and said impregnation product, is between 5 hours and 72 hours.
said method further comprises, after the impregnating step, a curing step wherein tubes, tube sheets as well as baffle(s) are heated at a temperature between 5° and 250° C., during a duration between 5 hours and 24 hours.
the thickness (t30) of bonding film (30) is between 0.005 mm and 0.5 mm, in particular between 0.01 mm and 0.1 mm.
the thickness (t22) of tube wall (22) is between 1 and 7 mm, advantageously between 2 mm and 5 mm.
the spacing (S2) between the outer faces of two adjacent tubes is between 0.5 mm and 6 mm, advantageously between 1 mm and 3 mm.

A second object of invention is a heat exchange graphite assembly (1), in particular manufactured by a method as above defined, said assembly being intended to be part of a tube bundle heat exchanger (I), said assembly comprising
a plurality of tubes (2) forming a bundle (20)
two tube sheets (4, 5) provided at opposite ends of said tubes, each tube sheet comprising through holes (20) for the reception of opposite ends (3, 3′) of said tubes
at least one baffle (6, 7) provided at intermediate location of said tubes, each baffle comprising openings (60) for the passage of said tubes
said tubes, said tube sheets as well as said baffle(s) being made of a graphite material, said graphite material being at least partly filled with an impregnation product, different from a cement
   said graphite assembly (1) being characterized in that, at each opposite end (3, 3′) of each tube, a continuous bonding film (30) made of said impregnation product is interposed between the facing walls of said tube (2) and said hole (20), so as to attach a respective end of each tube to a respective tube sheet.

According to advantageous features of this heat exchange graphite assembly:
the thickness (t30) of bonding film (30) is between 0.005 mm and 0.5 mm, in particular between 0.01 mm and 0.1 mm.
the thickness (t22) of tube wall (22) is between 1 and 7 mm, advantageously between 2 mm and 5 mm.
the spacing (S2) between the outer faces of two adjacent tubes is between 0.5 mm and 6 mm, advantageously between 1 mm and 3 mm.
said tube has two straight ends (3, 3′).

A third object of invention is a tube bundle heat exchanger comprising
a heat exchange graphite assembly (1), as defined above,
a shell (100) surrounding said assembly, the tube sheets (4, 5) of said assembly being attached to the inner wall of said shell, said shell comprising
first inlet means (110, 112, 114) for the inlet of a first fluid into the tubes (2) of the assembly (1)
first outlet means (120, 122, 124) for the outlet of said first fluid out of the tubes (2) of the assembly (1)
second inlet means (150) for the inlet of a second fluid into a heat exchange volume (140) formed between the facing walls of said tubes and said shell
second outlet means (150) for the outlet of said second fluid out of said heat exchange volume (140).

### DESCRIPTION OF THE FIGURES

The invention will be described hereinafter, with reference to the appended drawings, given by way of non-limiting example, wherein:

FIG. 1 is a front view, illustrating a tube bundle heat exchanger, which is equipped with a heat exchange graphite assembly according to the invention;

FIG. 2 is a perspective view, illustrating more specifically the heat exchange graphite assembly according to the invention;

FIG. 3 is an end view, illustrating in more detail and at a greater scale one tube which is part of the bundle belonging to the assembly of FIG. 2;

FIG. 4 is a front view, illustrating more specifically a tube sheet which is part of the assembly of FIG. 2;

FIG. 5 is a front view, showing at greater scale the detail V of FIG. 4;

FIG. 6 is a front view, illustrating more specifically a baffle which is part of the assembly of FIG. 2;

FIG. 7 is a front view, showing at greater scale the detail VII of FIG. 6;

FIG. 8 is a schematic view, illustrating a step of creation of a preform of the assembly of FIG. 2;

FIG. 9 is a front view, illustrating at great scale the preliminary positioning of the tubes with respect to the tube sheet;

FIG. 10 is a front view, analogous to FIG. 9, illustrating the preliminary positioning of the tubes with respect to the baffles;

FIG. 11 is a front view, analogous to FIG. 4, illustrating the attachment of the tubes with respect to the tube sheet;

FIG. 12 is a front view, showing at greater scale the detail XII of FIG. 11;

FIG. 13 is a longitudinal cross-section, illustrating under another angle the attachment of the tubes with respect to the tube sheet;

FIG. 14 is a longitudinal cross-section, illustrating at a great scale the insertion of a tube into a hole of the tube sheet, according to prior art;

FIG. 15 is a longitudinal cross-section, analogous to FIG. 13, illustrating the attachment of the tubes with respect to the tube sheet according to prior art;

FIG. 16 is a front view, analogous to FIG. 11, illustrating under another angle the attachment of the tubes with respect to the tube sheet according to prior art;

FIG. 17 is a front view, showing at greater scale the detail XVII of FIG. 16.

FIG. 18 is a longitudinal cross-section, illustrating at still a greater scale the detail XVIII of FIG. 14, in particular a line of pores extending at the interface between cement and graphite material.

### DETAILED DESCRIPTION OF THE INVENTION

The following reference numbers will be used throughout the present description
I heat exchanger according to the invention
1 assembly of the invention—2 tube—20 bundle
D2 diameter of 2—S2 spacing tubes 2
22 annular wall of tube—t22 thickness
23, 24 inner and outer faces of the tube
3, 3′ opposite ends of the tube—4, 5 tube sheet
40 through holes in tube sheet—6, 7 baffle
60 openings in baffles—D60 diameter of 60
100 shell—A100 longitudinal axis of shell
110 cover of exchanger I—112 inlet duct of 110
114 admission chamber—120 bottom of exchanger I
122 outlet duct of 120—124 discharge chamber
130 main cylindrical region of exchanger I
140 heat exchange volume
150, 160 inlet and outlet pipes of I—201 preform
230 clearance tube and tube sheets—t230 thickness
235 intercalary space between tube and baffle
30 film bonding tube and tube sheets—t30 thickness
II exchanger according to prior art
502 and following: same as 2 and following
530 cement layer—t530 thickness—LP line of pores

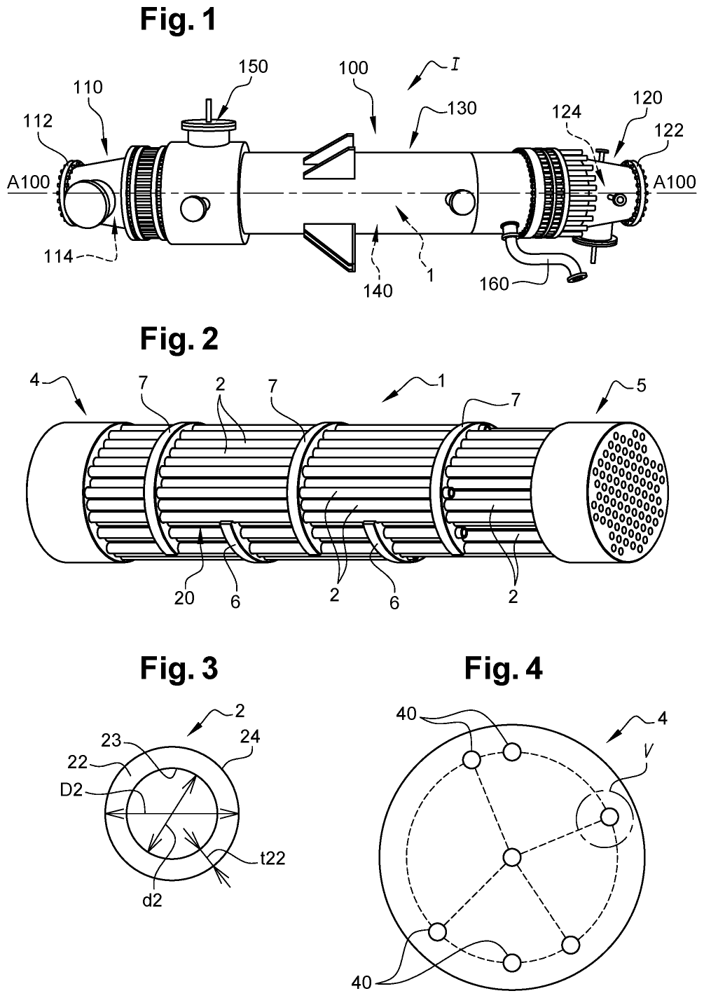

FIG. 1 illustrates a heat exchanger, referenced I as a whole. This exchanger firstly comprises a shell 100, the main longitudinal axis of which is noted A100. This shell defines a cover 110 at one first end, a bottom 120 at the opposite end, as well as a main cylindrical region 130. As will be described in further detail, region 130 defines a so-called heat exchange volume 140.

Said shell 100 accommodates a heat exchange graphite assembly according to the invention, which is referenced 1 as a whole. As shown on FIG. 2, this assembly essentially comprises a plurality of tubes 2, two end tube sheets 4 and 5, as well as baffles 6 and 7. The structure and the manufacturing method of this assembly will be detailed thereafter.

Cover 110 is equipped with a duct 112 intended for the inlet of a first or process fluid into the tubes 2 of the assembly 1. This inlet is connected with a source of this fluid, which is situated upstream and is not illustrated. Said duct 112 leads, via an admission chamber 114, to the heat exchange volume 140.

Moreover, the bottom 120 is equipped with a further duct 122 for the outlet of the first fluid outside the longitudinal tubes 2. This duct is provided downstream heat exchange volume 140, via a discharge chamber 124. In a way known as such, duct 122 is connected with a recovery tank, which is not illustrated.

In a way known as such shell 100 is further equipped with respective inlet 150 and outlet 160 pipes of a second or service fluid, respectively connected with a source and a recovery tank. Said second fluid is intended to be placed in heat exchange with the first fluid, in the aforementioned heat exchange volume 140.

FIG. 3 illustrates one 2 of the tubes, which are mutually identical and form a bundle 20. Tube 2, which has a circular cross-section, defines an annular wall 22 having an inner face 23 and an outer face 24. The characteristic dimensions of this tube will be detailed at the end of the present description.

Tube 2, which is made of graphite, is produced by any appropriate process. The latter typically comprises at least part of known steps amongst mixing, extrusion, carbonization and high temperature treatment. The graphite material of this tube, which is similar to prior art, has a thermal conductivity which is advantageously of at least 20 W.m.K, typically between 50 W.m.K and 80 W.m.K.

Moreover this graphite material has a so-called first value of porosity, which is rather high. As a consequence this graphite is permeable to liquids. This brings about a need for impregnate this graphite, so that it might be adapted to its intended final use.

FIG. 4 illustrates one 4 of the tube sheets, bearing in mind that the other one 5 is identical. This tube sheet 4 is made of substantially the same material, as tubes 2. In addition the manufacturing process of this sheet, as well as its properties, are similar to those of each tube.

Tube sheet 4, which has a cylindrical shape, is provided with means adapted to ensure its attachment and its sealing on the inner wall of the shell 100. These means, which are not shown, are of any appropriate type known by those skilled in the art.

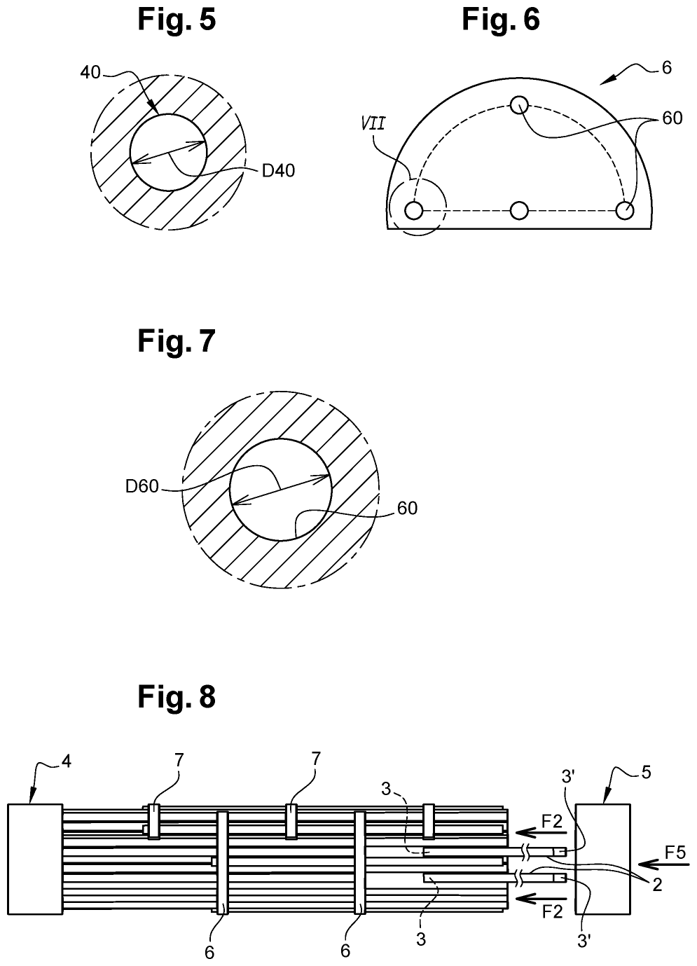

Tube sheet 4 is provided with a plurality of through holes 40, which extend perpendicular to its main plane. These holes are manufactured by any appropriate way, in particular by machining. With reference to FIG. 5, let us note the diameter D40 of each hole 40: in a typical way, the difference (D40−D2) is between 0.01 mm (millimeter) and 1 mm. As it will be detailed hereafter, the value of this difference is of importance since it determines the thickness of the bonding film between tube and tube sheet.

FIG. 6 illustrates one of the baffles, which is referenced as 6, bearing in mind that the structure of the other baffles 7 is identical. The material, the manufacturing process and the properties of this baffle, which are similar to those of the tube sheets 4 and 5, are also known as such.

Baffle 6 is provided with a plurality of through openings 60, which extend perpendicular to its main plane. These openings are manufactured by any appropriate way, in particular by machining. With reference to FIG. 7, let us note the diameter D60 of each opening 60: contrary to D40, the value of D60 is not of much importance. In a way known as such, the difference (D60−D2) shall be sufficient to allow a convenient assembling between tubes and baffles. Moreover this difference shall be not too high, so as to avoid untimely bypass of fluid between the tubes and the walls of the holes provided in the baffle.

An essential feature of the invention provides the creation of a preform 201, which is constituted by the same mechanical elements as those of the final heat exchange assembly 1. According to an advantageous embodiment, this preform is directly mounted in a not shown vessel adapted to receive an implementation product. First one tube sheet 4 as well as the baffles 6 and 7 are immobilized with respect to the walls of this vessel, via any appropriate mechanical means.

Each tube is then moved along its main direction, according to arrow F2 on FIG. 8. First end 3 of each tube is successively inserted into the openings of the different baffles, as well as the holes of the tube sheet 4. Afterwards the other tube sheet 5 is moved along arrow F5, so that its holes cooperate with the opposite end 3′ of the tubes. This operation is substantially similar to the one part of prior art manufacturing of Polytube®, with the difference that it is carried out with not impregnated graphite.

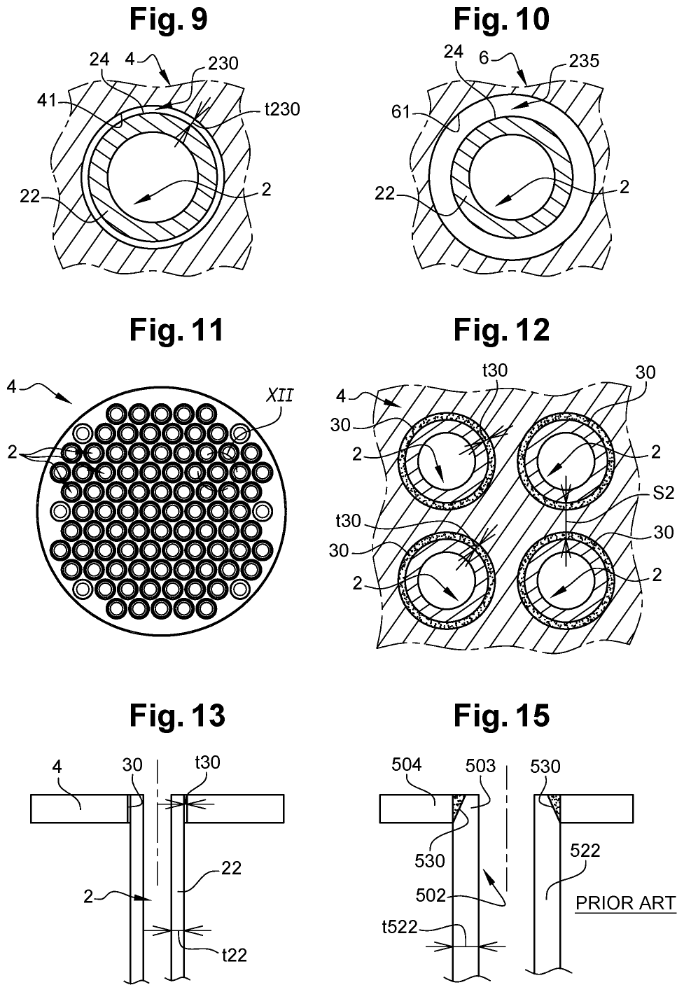

At the end of this operation, as shown on FIG. 9, outer face 24 of each tube 2 forms a clearance 230 with the facing wall 41 surrounding the hole 40 of the tube sheet. The transverse dimension or thickness t230 of this clearance is substantially the half of above defined difference (D40-D2), namely between 0.005 mm and 0.5 mm, in particular between 0.01 mm and 0.1 mm. On this FIG. 9, clearance 230 is represented as perfectly annular. In practice, tube 2 and hole 40 may be not strictly concentric. Therefore above value of t230 is an average value over the periphery of said clearance.

In an analogous way, as shown on FIG. 10, outer face 24 of each tube 2 forms an intercalary space 235 with the facing wall surrounding the opening of the baffle. It is to be noted that FIG. 9 in 10 are not at the real scale for sake of clarity.

The tubes, the tube sheets and the baffles define a preform 201 in which they are positioned the one with respect to the other, substantially in the final position they are intended to occupy. Moreover, at this stage, these elements have not been impregnated yet so that they are still porous.

It is to be noted that tubes, tube sheets and the baffles are not yet firmly attached the one with respect to the other. However the clearances 230 between tubes and tube sheets are small, and the baffles tend to ensure a stabilization function. Therefore the above elements are not likely to move the one with respect to the other, during the whole process.

Afterwards, the impregnation step of the method according to the invention is carried out. The impregnation product is chosen so as to fulfil two different functions. First this product shall impregnate the pores of the graphite material, in a way known as such. In addition this product shall fill the clearances 230, so as to tightly bond the walls of the tube with respect to the facing walls of the tube sheets.

By way of example, the impregnation product might be a phenolic resin, such as the one used in the manufacturing of prior art POLYTUBE®. As alternatives, those skilled in the art may choose other appropriate products, such as other types of resins.

In a practical way, this impregnation step may for example be carried out as follows. Impregnation product is first admitted in the vessel, wherein preform 201 is mounted. In an advantageous way, this admission is carried out from the bottom of the vessel, so as to reduce swirl phenomenon. This makes it possible to avoid any significant displacement of the mechanical elements, which are part of the preform.

Once impregnation product covers the entire preform, a contacting step between preform and impregnation product is carried out. In an advantageous way, the duration of this contacting step, also called contacting duration, is typically between 5 and 72 h. Thereafter impregnation product is finally evacuated, advantageously from the bottom of the vessel.

In a further step, the impregnated preform is advantageously heated at a temperature of between 50° C. and 250° C., during between 5 and 24 h. This heating step, known as such, makes it possible to create a thermosetting of the resin and render the graphite impervious.

Once the above steps have been carried out, the impregnated product is in a so-called hardened or solidified state. Therefore this renders liquid tight both tubes 2 as well as tube sheets 4 and 5. In this so-called impregnated state, the constitutive elements of the preform 201 have now a second value of porosity, which is far inferior to the first value which has been above mentioned. Due to this far lower porosity, the elements of the final assembly are now adapted to their intended use.

This impregnation also leads to the creation of a continuous film 30, as shown on FIGS. 12 and 13, which fills the above described clearance 230. This film has a thickness t30 corresponding to dimension t230 of the clearance, namely between 0.005 mm and 0.5 mm, in particular between 0.01 mm and 0.1 mm. This film 30 constitutes a continuous tight bond that makes it possible to firmly attach the tubes 2 with respect to each tube sheets 4 and 5. For the same reason as detailed above for clearance 230, though film 30 is represented as perfectly annular, it may have a slightly different shape. Under these conditions t30 is an average value over the periphery of said film.

On the other hand, the hardened impregnated product fills at least partly the intercalary space 235. This leads to the creation of a not shown intercalary layer, between tubes and baffles. Contrary to film 30, this layer does not need to be continuous and to create a tight bond between the tubes and the baffles.

The above steps, in particular creating tight bond between tubes and tubes sheet, lead to the formation of the final assembly 1. The latter is then accommodated in the shell 100, according to any appropriate manner. This stage is substantially the same as the one applied in the manufacturing of prior art exchange POLYTUBE®, as above described. This is advantageous, in terms of manufacturing convenience for the operators.

The invention makes it possible to achieve the above explained aims. In this respect, it shall be underlined that the applicant has identified the core issue, which brings about some drawbacks in the prior art exchangers. In particular the applicant has highlighted that the use of a cement leads to several technical problems.

As a reminder, a cement can be defined as a mixture of solid particles and of a binder. Once in place between the facing walls of the tubes and the tube sheets, this mixture is heat treated to cause irreversible hardening of the binder and ensure the mutual attachment between tubes and tube sheets.

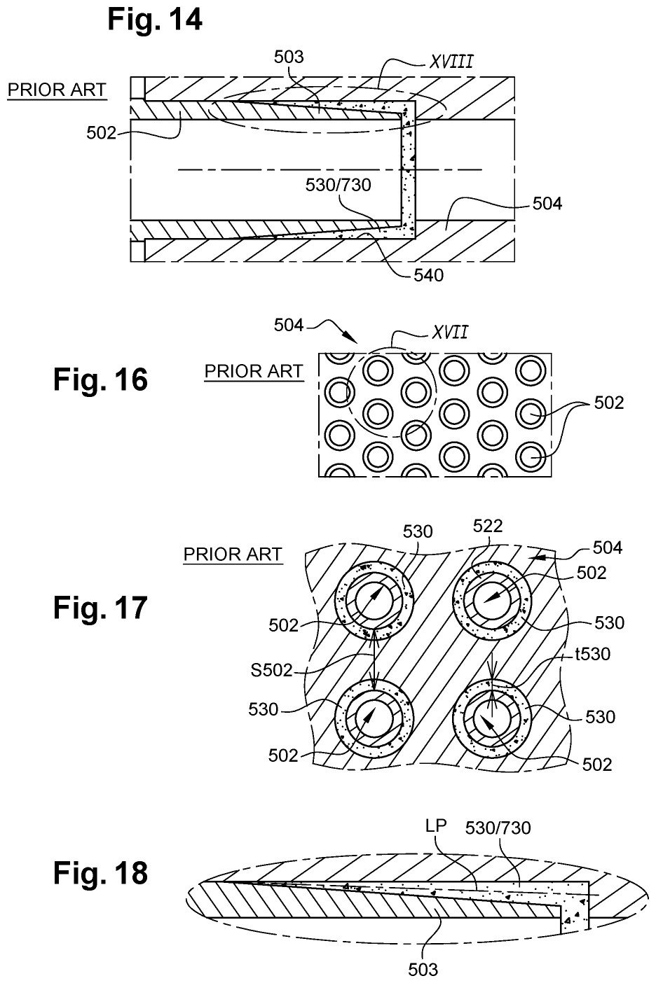

So as to illustrate the drawbacks due to the use of a cement, let us refer now to FIGS. 14 to 17 illustrating an exchanger II according to prior art. On these figures, mechanical elements which are analogous to those of exchanger I are given the same references, added by number 500.

As shown at great scale on FIG. 14, in prior art each tube 502 has a tapered end 503. The latter defines a free space 730, with facing walls surrounding holes 540 of tube sheet 504. Once this space 730 has been filled with a cement, the latter forms a layer referenced 530 on this FIG. 14.

This layer 530 is provided with a substantially continuous line of pores, which extends at the interface between cement and graphite materials. This line, which is referenced LP, is schematically illustrated on FIG. 18 which shows at a greater scale the detail XVIII of FIG. 14. The Applicant has acknowledged that these pores constitute a weak point with respect to the tightness of the assembly. Indeed this line of pores forms a so-called preferred path for a potential chemical attack by process fluid.

On the contrary, an essential feature of the invention foresees to avoid the cement previously used to attach tube and tube sheets. According to the invention, cement is replaced by above continuous bonding film 30, made of the same product also permitting impregnation of porous graphite.

In other words this product ensures, apart from its usual function of impregnation, a further function of bonding. On the contrary, it shall be underlined that a cement is not adapted to fulfil these two above-mentioned functions at the same time.

Under these conditions, the thickness t30 of this film 30 (see FIG. 12) is advantageously far inferior to that t530 of a cement layer 530 (see FIG. 17). Moreover each tube end, such as the one referenced 3 on FIG. 13, is straight which is more convenient for what concerns manufacturing process of these tubes.

In addition, avoiding the use of a cement makes it possible to save many costs in the manufacturing of the assembly according to the invention. As a summary, in prior art, tubes, tube sheets and baffles are first submitted to separate impregnation steps and then undergo several tedious mechanical operations. On the other hand, the invention foresees a preliminary positioning of these non-impregnated elements, and thereafter one single impregnation step. By way of example, it can be assumed that the invention permits 50% less workmanship, as well as 80% less process operations.

Suppression of cement also allows a substantial modification in the global arrangement of the tubes. Indeed, the manual assembling process of prior art imposes a minimal spacing, noted S502 on FIG. 17, between two adjacent tubes 502. This spacing, typically of at least 7 mm, is compulsory to allow access to the operator hand, as well as for leaving the free space 730 of FIG. 14.

On the contrary, the invention makes it possible to arrange adjacent tubes much closer than in prior art, since operators do not need to access between these adjacent tubes. Under these conditions, as noted on FIG. 12, the spacing S2 between outer walls 24 of adjacent tubes may be far inferior to the prior art one S502. By way of example, the value of this spacing S2 is between 0.5 mm and 6 mm, advantageously between 1 mm and 3 mm.

Moreover the prior assembling process imposes to use tubes, with a rather thick wall 522. This is compulsory, in particular to allow a tough handling by the operators. The wall thickness of each tube 502, referenced t522 on FIG. 15, is typically superior to 5 mm. This FIG. 15 also shows layer 530, in a schematic way.

The assembly of the present invention may comprise tubes of prior art, with the rather thick wall as described in the preceding paragraph. However, in a preferred manner, the invention permits using much thinner tubes, with a far inferior wall thickness. By way of example, said thickness t22 of wall 22 is between 1 mm and 7 mm, advantageously between 2 mm and 5 mm. In addition, with reference to FIG. 3, inner diameter d2 of the tube is advantageously between 5 and 40 mm and outer diameter D2 of the tube is advantageously between 7 and 55 mm.

Due to this preferred variant of the invention, more tubes are therefore likely to be mounted on a same size tube sheets. Thus, taking also into account the inferior thickness of the tube, the invention significantly increases the thermal performances of the exchanger. By way of example it can be assumed that an exchanger of the invention, with thinner tubes and closer adjacent tubes with respect to prior art, has a heat transfer area which is twice as high as prior art exchangers. Thermal conductivity may also be increased, by a factor of 2.

The present invention brings also some advantages, concerning the correct implementation of the exchanger. Thus, in prior art, manual mounting implies some defects, amongst which one is commonly called “over cementing”. In this occurrence, cement is mistakenly introduced inside some tubes, wherein it creates so-called scales which deposit against inner walls of the tubes. With time, some of these scales are likely to break away from the tubes, due to the liquid flow. These cement pieces may then move along the whole exchanger, where they can cause obstructions. According to the invention, which does not use cement any more, this untimely phenomenon is avoided.

The invention further permits a compact design of both the graphite assembly and the global exchanger. Under these conditions, less civil engineering is required, less carbon dioxide linked to transportation, as well as less steel for the shell manufacturing.

The invention makes it also possible to reduce the transportation risks. In this respect, the different mechanical elements can be sent in the form of a space saving kit, from the main manufacturing factory. These elements are then likely to be mutually assembled, in the local subsidiaries.

It shall be noted that the above-mentioned CN 107560463, CN 202648479 and CN113028864 are only part of background of the present invention. Indeed these documents are only concerned with impregnation process of the exchanger. However they are mute with respect to the mutual assembly of the constituting parts of this exchanger.

Moreover the exchanger of EP 0 744 587 does not face the same technical problem as in the present invention. Indeed silicon carbide, which forms the tube inserts of this exchanger, is impervious as such. Therefore this material does not have a porous state within the meaning of the invention and does not require an impregnation step.

1-15. (canceled)

16. A method of manufacturing method a heat exchange graphite assembly for a tube bundle heat exchanger, the heat exchange graphite assembly including a plurality of tubes forming a bundle, a pair of tube sheets provided at opposite ends of the plurality of tubes, each tube sheet having through holes for receiving the plurality of tubes, at least one baffle arranged at an intermediate location of the plurality of tubes, each baffle having openings for passage of the plurality of tubes, the method comprising:
providing the plurality of tubes, the tube sheets, and the at least one baffle in a graphite material being in a non-impregnated or porous state and having a first porosity value;
positioning the plurality of tubes, the tube sheets, and the at least one baffle in a porous state, respectively, and in a position that forms a clearance between facing walls of the plurality of tubes and the through holes; and
impregnating the plurality of tubes, the tube sheets, and the at least one baffle with an impregnation material different from cement, to fill the pores of the plurality of tubes, the tube sheets, and the at least one baffle, to thereby transform the graphite material to a second porosity value that is less than the first porosity value, form in the clearance a bonding film with the impregnation material, and attach the plurality of tubes with respect to the tube sheets.

17. The method of claim 16, wherein the clearance has a transverse thickness value of between 0.01 mm and 0.1 mm.

18. The method of claim 16, wherein no cement is inserted in the clearance.

19. The method of claim 16, wherein impregnating the plurality of tubes, the tube sheets, and the at least one baffle comprises:
placing the plurality of tubes, the tube sheets, and the at least one baffle in a vessel,
filling, from the bottom of the vessel, the vessel with the impregnation material to contact the plurality of tubes, the tube sheets, and the at least one baffle with the impregnation material, and
emptying the impregnation material from the vessel.

20. The method of claim 19, wherein a contact duration of the impregnation material with the plurality of tubes, the tube sheets, and the at least one baffle is between 5 hours and 72 hours.

21. The method of claim 16, further comprising, after impregnating the plurality of tubes, the tube sheets, and the at least one baffle, conducting a curing process by heating the plurality of tubes, the tube sheets, and the at least one baffle at a temperature of between 50° C. and 250° C. for a duration of between 5 hours and 24 hours.

22. The method of claim 16, wherein the bonding film has a thickness value of between 0.01 mm and 0.1 mm.

23. The method of claim 16, wherein each tube in the plurality of tubes has a wall thickness of between 2 mm and 5 mm.

24. The method of claim 16, wherein outer faces of adjacent tubes in the plurality of tubes are spaced between 1 mm and 3 mm.

25. A heat exchange graphite assembly for a tube bundle heat exchanger, the heat exchange graphite assembly comprising:
a plurality of tubes forming a bundle;
a pair of tube sheets provided at opposite ends of the plurality of tubes, each tube sheet having through holes for receiving the opposite ends of the plurality of tubes; and
at least one baffle, arranged at an intermediate location of the plurality of tubes, each baffle having openings for passage of the plurality of tubes,
wherein:
the plurality of tubes, the tube sheets, and the at least one baffle are formed from a graphite material at least partly filled with an impregnation material that is different from a cement, and
at each opposite end of each tube in the plurality of tubes, a continuous bonding film formed of the impregnation material is interposed between facing walls of each tube and a corresponding through hole to attach a respective end of each tube to a respective tube sheet.

26. The heat exchange graphite assembly of claim 25, wherein the bonding film has a thickness value of between 0.01 mm and 0.1 mm.

27. The heat exchange graphite assembly of claim 25, wherein each tube in the plurality of tubes has a wall thickness of between 2 mm and 5 mm.

28. The heat exchange graphite assembly of claim 25, wherein outer faces of adjacent tubes in the plurality of tubes are spaced between 1 mm and 3 mm

29. The heat exchange graphite assembly of claim 25, wherein each in the plurality of tubes has two straight ends.

30. A tube bundle heat exchanger, comprising:
a heat exchange graphite assembly that includes:
a plurality of tubes forming a bundle,
a pair of tube sheets provided at opposite ends of the plurality of tubes, each tube sheet having through holes for receiving the opposite ends of the plurality of tubes,
at least one baffle, arranged at an intermediate location of the plurality of tubes, each baffle having openings for passage of the plurality of tubes,
wherein:
the plurality of tubes, the tube sheets, and the at least one baffle are formed from a graphite material at least partly filled with an impregnation material that is different from a cement, and
at each opposite end of each tube in the plurality of tubes, a continuous bonding film formed of the impregnation material is interposed between facing walls of each tube and a corresponding through hole to attach a respective end of each tube to a respective tube sheet.
a shell that surrounds the heat exchange graphite assembly such that the tube sheets are attached to an inner wall of the shell, the shell having:
a first inlet to facilitate flow a first fluid into the plurality of tubes,
a first outlet to facilitate flow of the first fluid out of the plurality of tubes,
a second inlet to facilitate flow of a second fluid into a heat exchange volume formed between the facing walls of the plurality of tubes and the shell, and
a second outlet to facilitate flow of the second fluid from the heat exchange volume.
